(19) United States
(12) Patent Application Publication
(10) Pub. No.: US 2004/0196958 A1
(43) Pub. Date: Oct. 7, 2004

(54) Operating device for a diagnostic imaging unit

(76) Inventors: Werner Beck, Rueckersdorf (DE); Brigitta Lobenhofer, Neunkirchen am Brand (DE); Franz Meissner, Bamberg (DE); Axel Platz, Muenchen (DE)

Correspondence Address: SCHIFF HARDIN & WAITE, Patent Department, 6600 Sears Tower, 233 South Wacker Drive, Chicago, IL, 60606, US

(21) Appl. No.: 10/725,299

(22) Filed: Dec. 1, 2003

Related U.S. Application Data
(60) Provisional application No. 60/430,034, filed on Nov. 29, 2002.
(60) Provisional application No. 60/430,038, filed on Nov. 29, 2002.
(60) Provisional application No. 60/430,035, filed on Nov. 29, 2002.

(30) Foreign Application Priority Data
Nov. 29, 2002 (DE) 10255956.2

(51) Int. Cl. H05G 1/58

(52) U.S. Cl. 378/116

(57) ABSTRACT

The invention relates to an operating device for a diagnostic imaging unit. The operating device has a selection key for activating preset operating values and parameters of the imaging unit, and a setting key for manually setting operating values and parameters of the imaging unit. It also has a display element for displaying set operating values and parameters of the imaging unit. In accordance with the invention, the operating device makes available simultaneously with the display element either only the selection key or only the setting key.

### CROSS-REFERENCES TO RELATED APPLICATIONS

This application claims the benefit of U.S. Provisional Application No. 60/430,034, filed Nov. 29, 2002. This application is also related to U.S. Provisional Application Nos. 60/430,038 and 60/430,035, both also filed Nov. 29, 2002. All of these applications are herein incorporated by reference.

### BACKGROUND OF THE INVENTION

The invention relates to an operating device for a diagnostic imaging unit.

Diagnostic images are produced for medical diagnostics or else for materials science diagnostics. The imaging is frequently based on the production of radiation for penetrating the body to be examined. The imaging units used for this purpose have radiation sources whose operating variables can be set in multifarious ways. X-ray tubes can be used to generate X-radiation in-X-ray machines, computer tomographs and fluoroscopes; ultrasound transmitters are used in ultrasound units, or magnets and/or electromagnets are used in magnetic resonance units.

The object of an X-ray generator as an example of a radiation-based imaging unit consists chiefly in applying a preset tube voltage to an X-ray tube for an X-ray picture. A control device of the X-ray generator in this case controls the recording time, the tube voltage and the tube current such that the operating values set for the X-ray radiography are maintained. It is chiefly the tube voltage and the quantity of electricity, usually specified in mAs, that are set as operating values. Different operating values must be set depending on which part of a body of an examined living being is to be X-rayed, and on the diagnosis which this X-ray picture is to serve.

In clinical operating environments, there is a need for rational working methods and a high level of automation in order to permit efficient and economic operation. In order to facilitate setting the operating values and in order, in particular, to prevent erroneous settings, X-ray machines can be provided with “organ programs”. After preselection of an area of the body of the living being to be examined and of an X-raying direction, an “operating area”, the preset operating values for X-raying can be activated automatically by selecting an organ program.

There are frequently more than three different operating areas and more than six areas of the body available. Even at the stage of preselecting areas of the body and operating area, this produces an almost overwhelming number of possible selections. In order to activate a particular selection, an enormous quantity of operating elements (e.g., keys) must be provided. In addition, there are possible settings for further parameters, for example, with reference to the circumference of the living being to be examined, or with reference to the X-ray film material. The multiplicity of selection keys complicates the operation and runs counter to a rational mode of operation.

German patent document DE 33 30 116 A1 discloses a control device for an X-ray machine whose operating device renders the selection of areas of the body, operating areas and organ programs more user-friendly. For this purpose, the preselection of the area of the body is fashioned in a more intuitive and simpler fashion by means of a symbolic graphical representation. A selection of operating area and organ program is then performed via a matrix-shaped arrangement of keys that are systematically arranged and can thereby be efficiently surveyed. A disadvantage of this operating device is that no display is provided that indicates to an operator which preset operating values are activated by actuating a specific key.

Also known for X-ray machines are operating devices that have keys for the preselection of areas of the body and operating area as well as for selecting an organ program, and which permanently indicates all of the operating values and parameters for the purpose of better control. At the same time, keys are available for setting all of the operating values manually. Consequently, an operator is offered as many possibilities for setting and controlling as possible. It is a disadvantage of these operating devices that the multiplicity of selection keys precludes an overview of these control devices, and therefore renders them difficult to operate.

### SUMMARY OF THE INVENTION

The object of the invention is to create an operating device for the control device of a diagnostic imaging unit that permits both manual setting of operating values and parameters, and the activation of preset operating values and parameters, which in so doing indicates at any time to an operator all of the set operating values and parameters, but which nevertheless arranges all of the operating elements in a way that can be surveyed and is easy to understand, and which can thereby be operated intuitively and more quickly.

The invention achieves this object by an operating device for a diagnostic imaging unit, comprising: a selection key for activating preset operating values and parameters of the imaging unit; a setting key for manually setting operating values and parameters of the imaging unit; and a display element for displaying set or preset operating values and parameters of the imaging unit; the operating device being configured to simultaneously display the display element and only one of the selection key and the setting key.

Embodiments of the invention are designed to create an operating device for a control device of a diagnostic imaging unit that permanently displays all set operating values and parameters of the imaging unit, but that simultaneously makes available either exclusively keys for activating preset operating values and parameters, or else exclusively keys for manually setting operating values and parameters. The keys for activating preset operating values and parameters are therefore not made available simultaneously with the keys for manually setting these values.

By alternatively making available in each case only one type of key, the operating device is prevented from being overloaded with a multiplicity of superfluous operating elements. At the same, an operator is informed at any time of all current settings by the permanent display of the activated values. This is of great interest, in particular, for the activation of preset values by organ programs whose parameters need not be known in advance to the operator. On the one hand, thus, all important information is permanently displayed, while on the other hand, nonessential operating elements are blanked out. This improves the clarity of the operating device and facilitates its use. The operating device can be operated more intuitively and more quickly.

In an advantageous embodiment of the invention, the operating device may be fitted with an input device designed as a touch-sensitive display screen (touchscreen). The use of a touchscreen permits the operating elements to be rearranged and made available alternatively in a simple manner, depending on whether it is aimed to provide the possibility of activating preset values, or the possibility of setting values manually.

In a further advantageous embodiment of the invention, the operating device may have an input device that makes the operating elements for activating preset values, and the operating elements for manually setting these values respectively available in one and the same operating area. Consequently, an operator knows that operating elements are basically always found in the same area of the input device, and this facilitates and accelerates the possibility of finding them. This refinement can be implemented with particular ease by using a touchscreen.

In a further advantageous embodiment of the invention, the operating device may be used to control an X-ray machine, and has all of the operating elements required for this purpose. Specifically in the field of X-ray diagnostics, this is advantageous because medical staff who are not highly specialized professionally may be able to operate the X-ray machine. The invention aids in increasing the economy and reliability of operation, and thus also assists in reducing the patient's dose commitment.

Further advantageous embodiments of the invention are described below.

### DESCRIPTION OF THE DRAWINGS

Exemplary embodiments of the invention that relate to an X-ray machine are described in more detail below with the aid of figures.

FIG. 1 is a block diagram showing an X-ray machine having a control device;

FIG. 2 is a pictorial diagram showing an input device having operating elements for activating preset values or being operated in a program mode; and

FIG. 3 is a pictorial diagram showing an input device having operating elements for setting values manually or being operated in a manual mode.

### DETAILED DESCRIPTION OF THE PREFERRED EMBODIMENTS

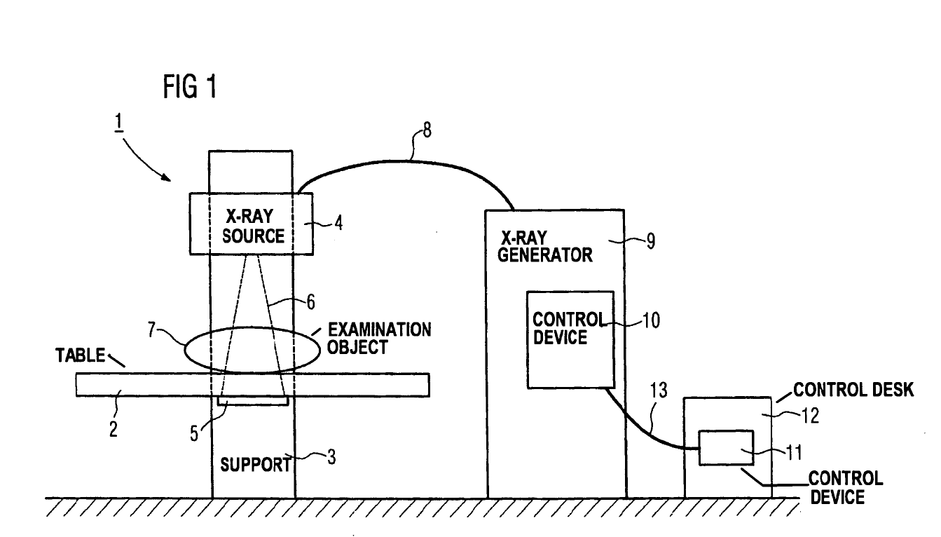

The X-ray machine 1 illustrated schematically in FIG. 1 comprises, in the case of the present exemplary embodiment, a patient table 2 (indicated only schematically) that is supported by a holding device (not illustrated in FIG. 1), and a supporting device 3 on which an X-ray source 4 is arranged. The X-ray source 4 may generally be formed by an X-ray tube. An X-ray cassette 5 arranged on the patient table 2 serves to obtain an X-ray image by way of an X-ray beam 6 that emanates from the X-ray source 4 and is attenuated when penetrating a living being or an examination object 7 to be examined (illustrated only schematically) and whose edge rays are drawn with dashes in FIG. 1.

The arrangement forms an X-ray operating area that typically X-rays the patient from above. Further operating areas are typified in that a patient is X-rayed, for example, from below, from the front or from the side.

Furthermore, an X-ray tube (not illustrated in FIG. 1) of the X-ray source 4 is connected to an X-ray generator 9 with the aid of an electric line 8. A control device 10 arranged in the housing of the X-ray generator 9 may use a computer program to control the X-ray generator 9 during X-raying in such a way that the operating values of tube voltage and quantity of electricity input by way of an operating/control device 11 before X-raying are maintained. The operating device 11 may be arranged at an operator console or control desk 12 and is connected to the control device 10 by way of an electric line 13.

Specific operating values must be set for an X-ray picture of a specific part of the body of a living being 7. These operating values are, primarily, the tube voltage and the quantity of electricity during X-raying, and these can be set by way of the operating elements of the operating device 11. In order to facilitate the setting of the specific operating values and, in particular, to prevent erroneous settings, the operating elements of the operating device 11 can be used to select preset operating values.

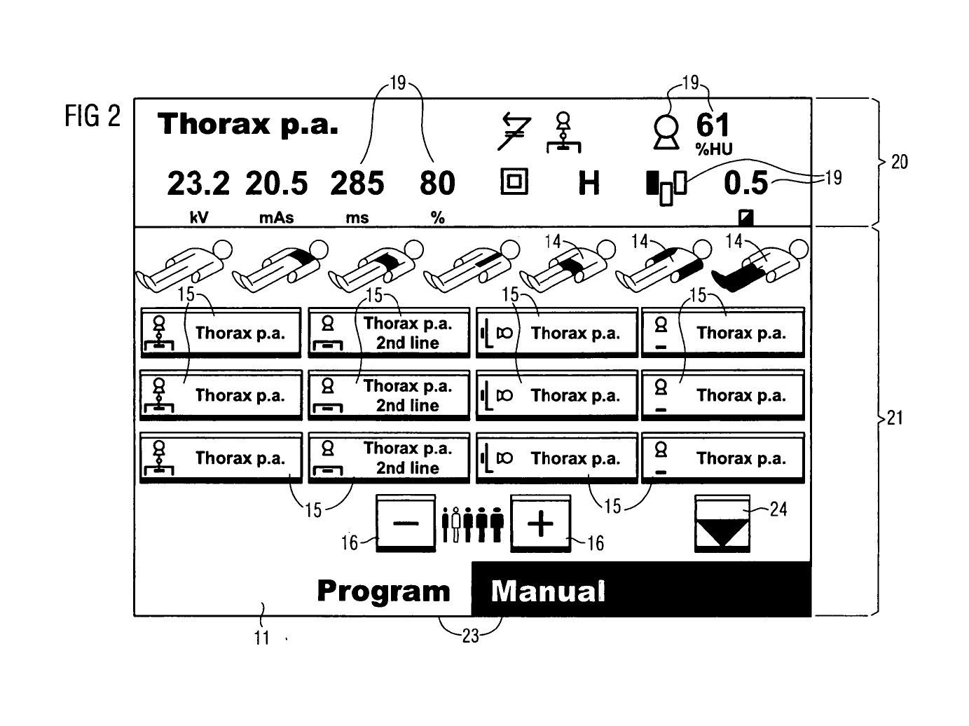

FIG. 2 illustrates the operating device 11 in accordance with an embodiment of the invention having operating elements for activating preset operating values and parameters of the X-ray machine 1. The operating device 11 can be designed as a touchscreen, for example. It may have a display area 20 within which the display elements 19 can be arranged. The display elements 19 may serve to display the currently activated operating values, for example, X-ray voltage in kV, quantity of electricity in mAs, or X-raying time in ms, as well as further parameters, for example, the thermal loading of the X-ray tube in % HU, or the preselected operating area by way of a symbolic graphical representation. A further display element 19 reproduces the name of the currently activated organ program, “thorax p.a.” in FIG. 2. In the selected division of the operating device 11, the display area 20 contains no operating elements of any sort, for example, keys or switches, that an operator would need to actuate.

The operating device 11 further may have an operating area 21 in which selection keys 14, 15, 16 for activating preset operating values and parameters are arranged. In this case, the body area keys 14 serve for preselecting the area of the body, to be examined, of a patient who is to be examined; they are illustrated symbolically in FIG. 2 as bodies for which the respectively preselectable area of the body is emphasized graphically. Furthermore, program keys 15 may be provided that serve the purpose of simultaneous selection of an operating area and an organ program; these program keys 15 may be designed, e.g., as rectangular keys that in each case have a graphical symbolic illustration of the operating area in the left-hand area, and a textural identification of the organ program, for example “thorax p.a.”, in the right-hand area.

Adjusting keys 16 may also be provided that, when actuated, can lower or raise in permanently prescribed steps the quantity of electricity that was preset on the basis of the selection of an organ program by actuating one of the program keys 15. The picture blackening can be corrected as a function of the circumference of the patient to be examined in order to compensate for anatomical differences. The adapting steps by actuating the adapting keys 16 may likewise be preset values, which are possibly preset such that the spectrum of body circumferences normally to be examined can be fully covered. It is also thereby possible for an operator not in possession of adequate knowledge of X-ray diagnostics to undertake adjustment in order to be able to estimate the changes in quantity of electricity that are required for this adjustment.

By actuating the recording key 24, X-ray pictures can be triggered at any time from the program mode illustrated in FIG. 2. X-raying is then performed with the aid of operating values and parameters currently activated and displayed in the display area 20.

The operating area 21 of the operating device 11 may have exclusively operating elements 14, 15, 16, which serve to activate preset values. The preset values available may be laid out such that they cover the various X-ray examinations occurring in the routine operation of the X-ray machine 1 in the respective clinical operating environment. They can, for example, cover the spectrum of X-ray examinations for an orthopedic, an internal or a neurological department. Consequently, even an operator who is not exceptionally conversant with the handling of the respective X-ray machine 1, or has only limited specialist knowledge of radiology, can immediately learn how to take such X-ray pictures.

At the same time, it is only the operating elements 14, 15, 16 required to activate preset values that are made available, and so an operator is not confused by further, unnecessary keys for manual activation of values. Manual activation of the values is seldom required in routine operation of the X-ray machine 1, and so operating elements for manual setting are not required.

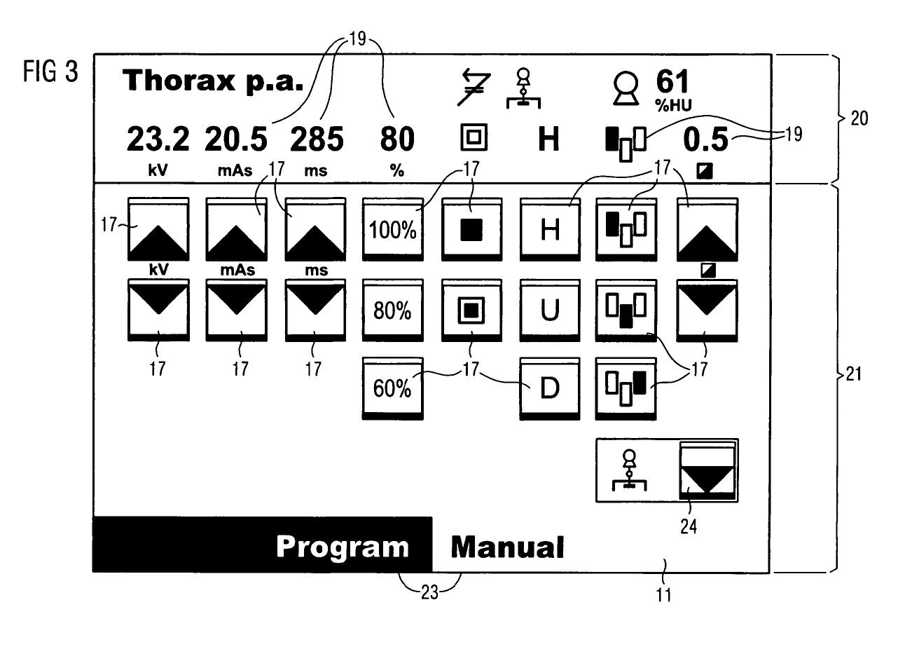

The operating area 21 may have further switchover keys 23 which, upon actuation, switch over the operating device 11 from the programming mode, illustrated in FIG. 2, for activating preset program values into a manual mode, illustrated in the following FIG. 3, for manually inputting these values. The switchover key 23 provided for this purpose is labeled “manual”. The switchover key 23 for switching over into the mode illustrated in FIG. 2 is labeled “program”.

FIG. 3 illustrates an exemplary embodiment of an operating device 11 with setting keys 17 for manually setting the operating values and parameters of an X-ray machine 1. The operating device 11 illustrated in FIG. 3 has a display area 20 that corresponds to the display area 20 of the embodiment of the operating device 11 previously illustrated in FIG. 2. The position and configuration of the display elements 19 are identical. This increases the recognizability for an operator, and accelerates and therefore facilitates handling of the operating device 11.

The operating device 11 may also have an operating area 21 which likewise corresponds in position and configuration to the operating area 21 previously illustrated in FIG. 2. However, it may contain other operating elements, specifically setting keys 17, for manually setting operating values and parameters. Setting keys 17 may be provided for all relevant operating values, for example X-ray voltage, quantity of electricity or X-raying times, and for all relevant parameters, for example X-ray tube exposure or operating area. In order to improve the visual orientation within the element of the operating device 11, the setting keys 17 may be arranged under the respectively associated display elements 19, for example, the setting keys 17 for the X-ray voltage directly below the display element 19 for the X-ray voltage, the setting keys 17 for the recording time directly below the display element 19 for the recording time, etc.

The operating area 21 illustrated in FIG. 3 has no operating elements 14, 15 or 16 of any kind for activating preset operating values and parameters. It is exclusively setting keys 17 for manually setting these values that are made available. The possibility of manually setting the values is directed primarily at the specialist in handling the X-ray machine 1 and/or in X-ray examinations taking place on the X-ray machine 1. No presettings are required if manual setting of the values is intended. Consequently, operating elements 14, 15, 16 for activating preset values are not required and are not illustrated simultaneously with setting keys 17 for manual setting in order to fashion the operating device 11 in clearer fashion. It is thereby easier to grasp visually and can be operated more intuitively and quickly.

The manual setting of all values can be performed, however, starting from previously activated preset values. For this purpose, it is possible first to switch into the “program” mode by actuating the corresponding changeover key 23, in order to activate preset values there, and subsequently to change into the “manual” mode, where the previously selected values are then available for manual processing. It is possible, for example, to use the preset values of a specific organ program that are to be used to vary an individual parameter, without first requiring all of the values of this program to be input manually. Instead of this, it is possible to activate the preset values and further manually process only the value to be varied.

By actuating the recording key 24, X-ray pictures can be triggered at any time from the program mode illustrated in FIG. 3. The X-raying is then performed with the aid of the operating values and parameters currently displayed in the display area 20. The operation of the operating device 11 may be substantially simplified in that triggering X-ray pictures is possible both from the program mode illustrated in FIG. 2, and from the manual mode illustrated in FIG. 3. This saves an operator from having firstly to switch to a mode that permits the triggering of X-ray pictures after he has set or activated all of the operating values.

In both the program input mode (FIG. 2) and the manual input mode (FIG. 3) illustrated, the operating device 11 has the same division into display area 20 and operating area 21. However, the operating elements 14, 15, 16, 17 made available to the user change. Such a flexible operating device 11 can be implemented in the simplest way by using a touch-sensitive display screen (touchscreen). A touchscreen offers the possibility of flexibly configuring and positioning both the display elements 19 and the operating elements 14, 15, 16, 17 of the operating device 11. This permits the invention to be realized in a particularly simple way. The operating device 11 could, however, also be designed as a normal display screen insensitive to touch, whose operating elements 14, 15, 16, 17 can be actuated by way of a keyboard or mouse. It may also be possible to implement this by using display elements in the form of LEDs or LCDs, and operating elements that are formed by keys, behind which could be placed LEDs or LCDs for signaling the respective function or availability of a key. Further designs based on mutually separated, different operating devices 11 for the program mode illustrated in FIG. 2 and the manual mode illustrated in FIG. 3 are likewise conceivable.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. An operating device for a diagnostic imaging unit, comprising:
a selection key for activating preset operating values and parameters of the imaging unit;
a setting key for manually setting operating values and parameters of the imaging unit; and
a display element for displaying set or preset operating values and parameters of the imaging unit;
the operating device being configured to simultaneously display the display element and only one of the selection key and the setting key.

2. The operating device as claimed in claim 1, wherein the operating device is designed as a touch-sensitive display screen.

3. The operating device as claimed in claim 1, further comprising a display area for displaying the display element.

4. The operating device as claimed in claim 1, further comprising an operating area for making available the selection key or the setting key.

5. The operating device as claimed in claim 1, further comprising a switchover key configured to switch between a display of the selection key and the setting key.

6. The operating device as claimed in claim 1, further comprising a recording key for triggering picture-taking that is made available both simultaneously with the selection key and simultaneously with the setting key.

7. The operating device as claimed in claim 1, wherein the diagnostic imaging unit is an X-ray machine.
